(19) United States
(12) Patent Application Publication
(10) Pub. No.: US 2016/0167208 A1
(43) Pub. Date: Jun. 16, 2016

(54) ELECTRONIC TORQUE WRENCH EQUIPPED WITH AUTOMATIC OUTPUT-TORQUE COMPENSATION DEVICE

(71) Applicant: ECLATORQ TECHNOLOGY CO., LTD., Taichung City (TW)

(72) Inventor: Ming-Hua LI, Taichung City (TW)

(21) Appl. No.: 15/048,802

(22) Filed: Feb. 19, 2016

Related U.S. Application Data
(63) Continuation-in-part of application No. 13/480,789, filed on May 25, 2012.

(30) Foreign Application Priority Data
Jun. 10, 2011 (TW) 100120315

(51) Int. Cl. B25B 23/142

(52) U.S. Cl. CPC B25B 23/1425

(57) ABSTRACT

An electronic torque wrench equipped with an automatic output-torque compensation device comprises an electronic torque wrench and replaceable wrench heads selectively installed in the electronic torque wrench. A torque-compensation setting module sets a length parameter corresponding to the specification of the wrench head. An allowable torque range conversion module and a torque-compensation conversion module respectively undertake conversions and compensations to update an allowable torque range of the electronic torque wrench and make a displayed torque equal to the torque actually output in operation. A display element presents the displayed torque and the updated allowable torque range. The user can directly learn the actually-output torque and the updated allowable torque range from the display element in realtime, neither looking up tables nor undertaking computations.

The present invention can increase convenience and reliability in usage and prevent from that excessive force damages the electronic torque wrench and insufficient force undertightens screws.

This application is a continuation-in-part, and claims priority, from U.S. patent application Ser. No. 13/480,789 filed on May 25, 2012, entitled “ELECTRONIC TORQUE APPARATUS EQUIPPED WITH AN AUTOMATIC COMPENSATION DEVICE WITH OUTPUT TORQUE”, the entire contents of which are hereby incorporated by reference.

This application claims the priority benefit of Application No. 100120315 filed in Taiwan on Jun. 10, 2011.

### FIELD OF THE INVENTION

The present invention relates to a torque wrench, particularly to a torque wrench able to automatically compensate for the displayed torque and allowable torque range.

### BACKGROUND OF THE INVENTION

Please refer to FIG. 1 for a conventional torque wrench with changeable wrench heads. The conventional torque wrench includes a torque bar 2, a display element 3, a torque detection element 4 and a control system 5. When in use, it is coupled with a wrench head 1.

While the wrench head 1 is used to fasten a screw head (not shown in the drawings), the torque detection element 4 disposed in the torque bar 2 detects deformation amount of the torque bar 2, and the control system 5 calculates output torque corresponding to the deformation amount of the torque bar 2 so that the output torque is displayed on the display element 3 for users.

The user normally uses a setting button 7 to preset the torque that he intends to apply to a screw before he tightens the screw. While the applied torque reaches the preset value, a warning system 8 sends out a warning signal to inform the user that the torque has reached the preset value.

Refer to FIG. 2. The wrench head 1 is a standard one of the torque wrench. While a torque T (referred to as an actually output torque below) is applied to a screw (not shown in the drawing) through a screw coupling head 6, the torque detection element 4 detects the corresponding standard deformation amount of the torque bar 2, and the control system 5 calculates an output torque value corresponding to the deformation amount of the torque bar 2 and controls the display elements 3 to display the output torque value. In other words, while the standard wrench head 1 is used, the torque value displayed by the display element 3 is identical to the actually output torque without errors.

Speaking more technically, the manufacturers of the electronic torque wrenches design or manufacture according to the standard wrench head 1. In other words, the torque value displayed by the display element 3 of the electronic torque wrench is fortuitously identical to the actually output torque of the electronic torque wrench. The deformation range of the torque bar 2 at the position of the detection element 4 is designed according to the maximum and minimum forces applied by the electronic torque wrench using the standard wrench head 1. While the electronic torque wrench applies the maximum force, the torque bar 2 is required to withstand the corresponding deformation amount. Once the applied force is released, the torque bar 2 must resume the original status without any plastic deformation lest the electronic torque wrench be damaged. While the electronic torque wrench applies the minimum force, the signal generated by the deformation amount of the torque bar 2 must be great sufficiently, normally 1000 times greater than the noise of the electronic torque wrench, i.e. the influence of the noise to the precision of the measurement at the minimum applied force is 0.1%. Thereby, it is guaranteed that the electronic torque wrench can apply the tightening torque to the screw at the desired precision. Therefore, the electronic torque wrenches are respectively labelled with their allowable ranges of applied torque, normally within the 20-100% of the maximum output torque of the electronic torque wrench. The signal of the applied force lower than 20% of the maximum output torque is too weak with respect to the noise (less than 1000 times the noise) and will have a poor measurement precision. The applied force greater than 100% of the maximum output torque will cause the plastic deformation of the torque bar 2 and damage the electronic torque wrench. Hence, the torque setting range of an electronic torque wrench is normally within 20-100% of the maximum output torque, and the user cannot set the force exceeding the range.

Refer to FIG. 3. A different type of wrench head 1A is used to meet a different operation requirement. As the wrench head 1A is formed in a size different from that of the standard wrench head 1, the distance L1A between the screw coupling head 6 and the force applying center (as shown in FIG. 3) is different from the distance L1 of the standard drive head 1 (as shown in FIG. 2). Hence, even though the same torque T is applied to the torque wrench equipped with the standard wrench head 1 and another torque wrench equipped with the wrench head 1A, the deformation amounts of the torque bar 2 at the detection elements 4 are different. Thus, the torque values calculated by the control systems 5 and displayed on the display elements 3 are also different. In other words, the torque value displayed on the display element 3 of the torque wrench equipped with the standard wrench head 1 is exactly equal to the actually output torque, and the torque value displayed on the display element 3 of the torque wrench equipped with the wrench head 1A is unequal to the actually output torque. The fact that the torque displayed by the display element 3 is different from the actually output torque will make the user unable perform screw fastening well.

Speaking more technically, while two torque wrenches respectively use different types of wrench heads 1 and 1A, an identical torque will make the torque bars 2 of the two different torque wrenches respectively have different deformation amounts; while the torque bars 2 of two torque wrenches respectively using different types of wrench heads 1 and 1A need an identical deformation amount, they would respectively require different torques. The allowable range of applied torque is designed according to the torque wrench using the standard wrench head 1. In other words, while the torque wrench is using the standard wrench head 1, the minimum allowable deformation (the minimum allowable applied torque) thereof and the maximum allowable deformation (the maximum applied torque) of the torque bar 2 are used to determine the limits of the applied torque of the torque wrench. While the torque wrench is using the wrench head 1A, the allowable range of applied torque will vary although the limits of the deformation of the torque bar 2 keep the same.

Speaking simply, while using different types of wrenches 1 and 1A, the same torque wrench has different ranges of allowable applied torque (different maximum torques and different minimum torques).

While the user adopts different types of the wrench heads 1 and 1A in a current electronic torque wrench, he must use a torque conversion formula of the torque wrench to convert the intended output torque into the displayed torque presented on the display element and then looks at the display element 3 to operate the electronic torque wrench.

The abovementioned conventional operation approach is quite inconvenient. The user cannot operate the torque wrench appropriately unless he converts the actually applied torque into the displayed torque. While adopting different types of wrench heads 1 and 1A available in the market, the user is hard to make accurate measurement of the lengths thereof Even though the user acquires the correct lengths, calculation mistakes also may occur. As the displayed torque and actually output torque value are different, users cannot be instantly aware of the fastening status of screws. All these factors create a lot of problems. Besides, the operation range of torque in the conventional torque wrench is fixed within 20-100% of the allowed maximum output torque. Replacing the standard wrench head with another wrench head may decrease the operation range and waste the operation capability of the torque wrench.

### SUMMARY OF THE INVENTION

Hence, the primary object of the present invention is to provide an electronic torque wrench equipped with an automatic output-torque compensation device that can automatically correct torque errors caused by change of different wrench heads, update the allowable torque range after calibration, and avoid serious mistake caused by human calculation errors. In the present invention, lengths, numerals, or symbols are fabricated on various types of wrench heads; compensation modes corresponding to different types of wrench heads are preset in the automatic output-torque compensation device. When the user desires to change the wrench head, he can use the automatic output-torque compensation device to quickly select or set the corresponding compensation mode. Thereby, the user not only can update the allowable torque range of the electronic torque wrench but also can set a torque identical to the target torque that he intends to output. The present invention can further inform the user of the event that the target torque that the user intends to output exceeds the updated allowable torque range. Moreover, during operation of the electronic torque wrench, because the torque value instantly displayed on a display element is the same as the actually output torque value, the user can learn the correct operation torque in realtime and uses the electronic torque wrench freely.

To achieve the abovementioned objective, the present invention proposes an electronic torque wrench equipped with an automatic output-torque compensation device, which comprises an electronic torque wrench, a plurality of replaceable wrench heads, a torque-compensation setting module, a torque-compensation conversion module, an allowable torque range conversion module and a display element.

The replaceable wrenches respectively have different specifications, selectively installed in the electronic torque wrench. The torque-compensation setting module is disposed in the electronic torque wrench and sets the length parameter of the selected wrench head according to the specification of the selected wrench head. The allowable torque range conversion module is disposed in the electronic torque wrench and undertakes conversion and compensation according to the length parameter set by the torque-compensation setting module to change the allowable torque range of the electronic torque wrench. The torque-compensation conversion module is disposed in the electronic torque wrench and undertakes conversion and compensation according to the length parameter set by the torque-compensation setting module to enable the electronic torque wrench to instantly present a displayed torque identical to the torque actually output in operation. The display element presents the displayed torque and the allowable torque range.

In addition to updating the allowable torque range in realtime, the present invention also enables the user to set the torque value identical to the target torque, which the user intends to output, in the electronic torque wrench, and alarms the user while the output torque the user sets before changing the wrench head exceeds the allowable torque range updated after changing the wrench head. While the user operates the electronic torque wrench of the present invention, the torque instantly presented by the display element is identical to the torque actually output at the same time. The user is exempted from looking up tables or undertaking conversions. Thus is increased convenience and reliability in usage. In the present invention, a symbol denoting a length or a number is fabricated on various types of wrench heads, and compensation selection items corresponding to different wrench heads are built in the automatic compensation device. While the user replaces the wrench head, he can uses the automatic compensation device to fast select the corresponding selection item and then uses the electronic torque wrench promptly and correctly.

Therefore, while the user changes the wrench head, the automatic compensation device of the present invention undertakes automatic compensation to vary the allowable torque range of the electronic torque wrench, and make the torque instantly presented by the display element identical to the torque actually output at the same time. Besides, the display element presents the displayed torque and the allowable torque range. Thereby, the user can learn the displayed torque and the allowable torque range directly and instantly without using formulas to undertake conversions. Thus, the present invention can increase operation convenience, avoid computation errors, and prevent from that excessive force damages the electronic torque wrench and that insufficient force leads to poor tightening of screws. As the automatic compensation device of the present invention can undertake automatic compensations to make the displayed torque identical to the torque actually output at the same time and update the allowable torque range, the user can learn the correct torque in realtime and operate the electronic torque wrench freely.

### BRIEF DESCRIPTION OF THE DRAWINGS

FIG. 1 is a diagram showing the structure of a conventional torque wrench;

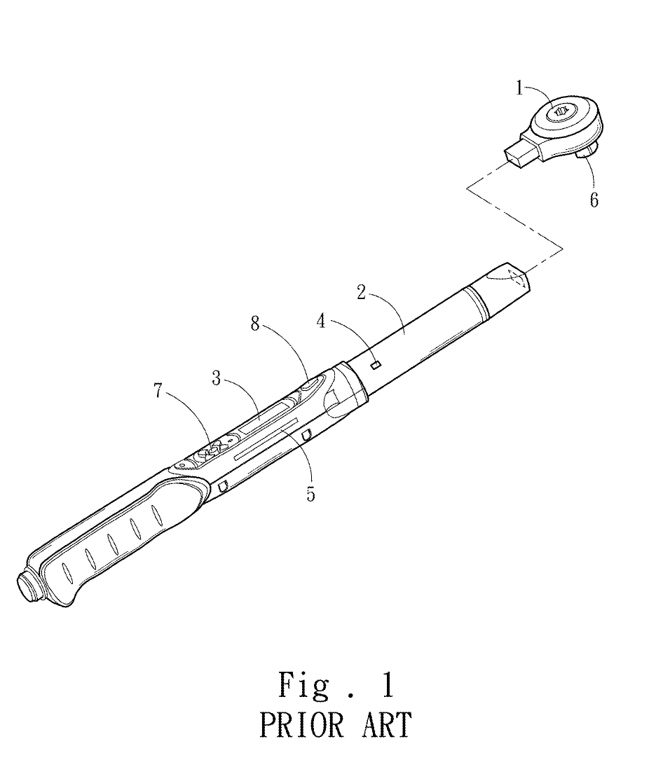

FIG. 2 is a diagram showing the structure of a conventional torque wrench combined with a wrench head;

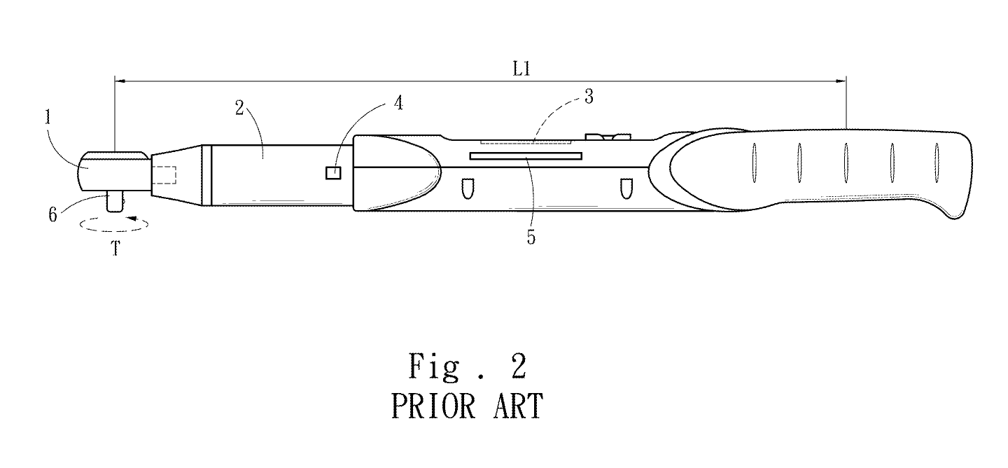

FIG. 3 is a diagram showing the structure of a conventional torque wrench combined with another wrench head;

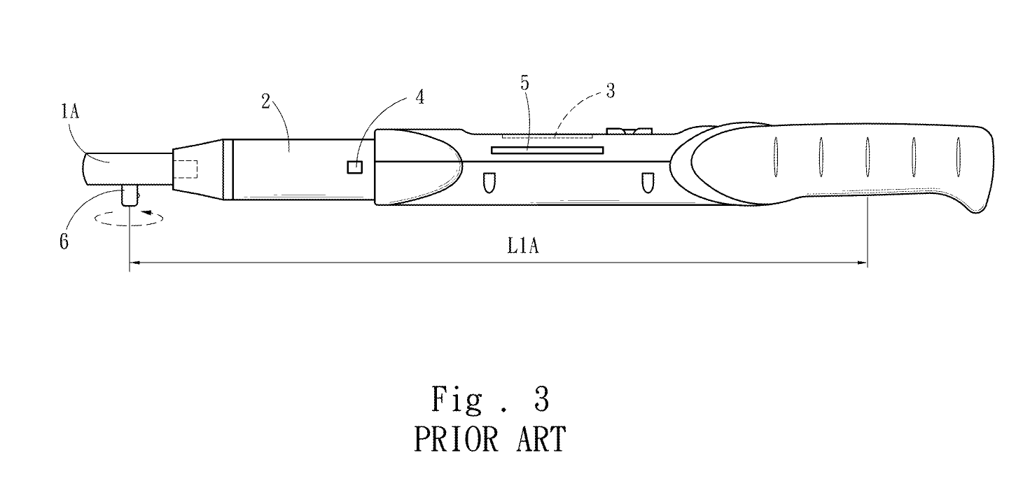

FIG. 4 is a diagram schematically showing the structure of an electronic torque wrench equipped with an automatic output-torque compensation device according to one embodiment of the present invention; and

FIG. 5 is a diagram schematically showing length parameters of wrench heads of an electronic torque wrench equipped with an automatic output-torque compensation device according to one embodiment of the present invention.

### DETAILED DESCRIPTION OF THE PREFERRED EMBODIMENTS

The technical contents of the present invention will be described in detail below.

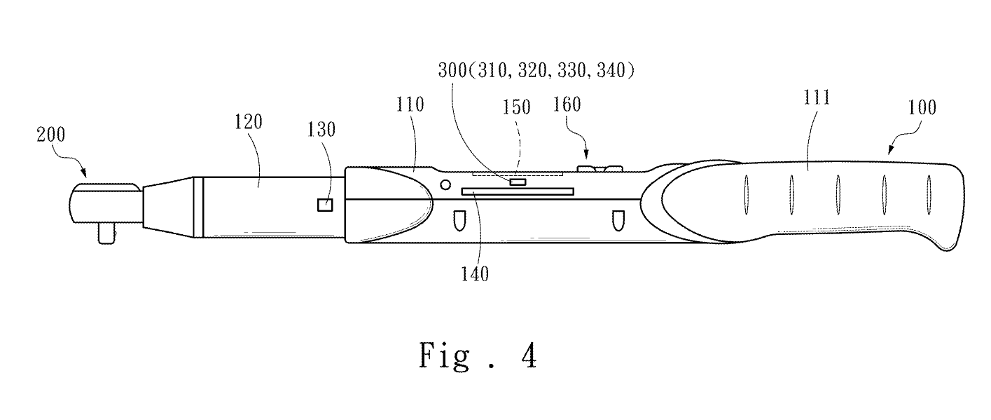

Refer to FIG. 4. The present invention proposes an electronic torque wrench equipped with an automatic output-torque compensation device, which comprises an electronic torque wrench 100, a plurality of replaceable wrench heads 200, and an automatic compensation device 300.

The electronic torque wrench 100 further comprises a casing 110, a torque bar 120, a torque detection element 130, a control system 140, a display element 150 and a setting element 160. The casing 110 includes a handle 111 to be held by the user. One end of the torque bar 120 is inserted into and integrated with the casing 110. The torque detection element 130 is disposed in the torque bar 120 to detect the deformation amount of the torque bar 120. The control system 140 is disposed inside the casing 110 and electrically connected with the torque detection element 130, calculating the force applied by the electronic torque wrench 100 and corresponding to the deformation amount of the torque bar 120. The control system 140 is also electrically connected with the display element 150 and controls the display element 150 to present the force applied by the electronic torque wrench 100 and worked out by the control system 140. The setting element 160 is disposed on the casing 110, electrically connected with the control system 140, and used by the user to set the corresponding parameters of the electronic torque wrench 100.

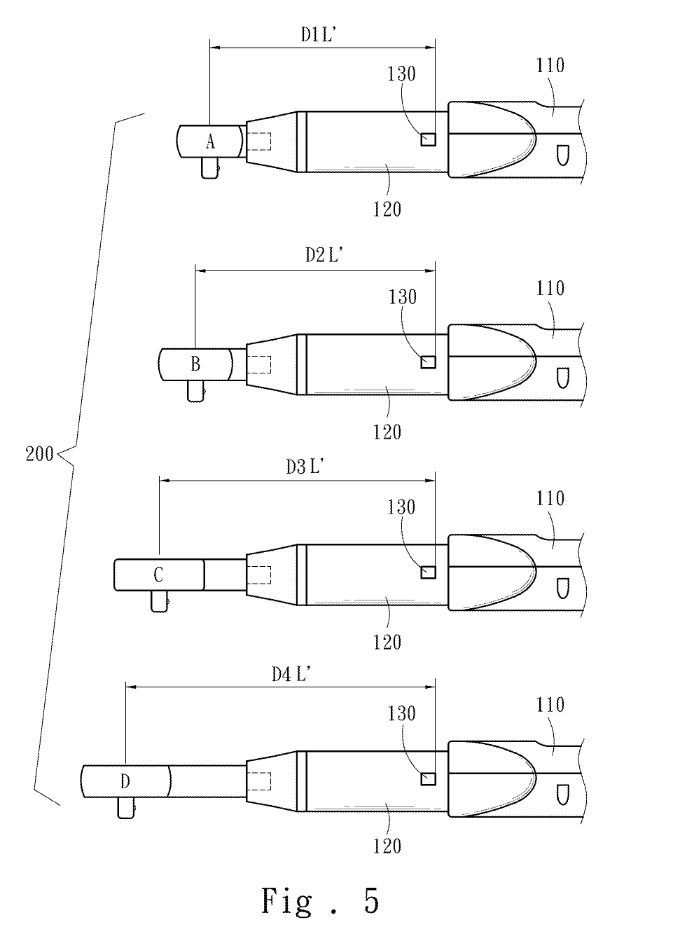

Refer to FIG. 5. The wrench heads 200 respectively have different specifications, selectively installed in another end of the torque bar 120 of the electronic torque wrench 100, whereby to rotate a worked screw (not shown in the drawing). As the wrench heads 200 respectively have different sizes, the distances between the rotation centers of the worked screws to the torque detection element 130 (D1L′, D2L′, D3L′, and D4L) are different, which results in that the torque presented on the display element 150 is deviated from the torque output actually while the wrench head 200 is replaced with another one having a different specification.

Refer to FIG. 4 again. A torque-compensation setting module 310, a torque-compensation conversion module 320, an allowable torque range conversion module 330 and a memory module 340 are built in the automatic compensation device 300. The automatic compensation device 300 is disposed inside the control system 140. The memory module 340 stores a plurality of compensation modes corresponding to the specifications of the wrench heads 200. The setting element 160 is electrically connected with the control system 140 and used by the user to operate and set the torque-compensation setting module 310. According to the specification of the wrench head 200 adopted by the electronic torque wrench 100, the torque-compensation setting module 310 selects the corresponding compensation mode from the memory module 340. Speaking in detail, the compensation modes undertake conversions with specified formulas, which respectively have different compensation proportions and compensation values for the different lengths of the wrench heads 200 adopted by the electronic torque wrench 100. In other words, the compensation modes can be implemented by specified formulas stored in the memory module 340.

The allowable torque range conversion module 330 undertakes conversion and compensation according to the compensation mode selected by the torque-compensation setting module 310 to vary the allowable torque range of the electronic torque wrench 100. The torque-compensation conversion module 320 undertakes conversion and compensation according to the compensation mode selected by the torque-compensation setting module 310 to make the displayed torque equal to the torque actually output by the electronic torque wrench 100. The display element 150 presents the displayed torque and the allowable torque range. No matter what type of wrench head the electronic torque wrench uses, the torque-compensation conversion module 320 and the allowable torque range conversion module 330 can undertake compensation for it. Refer to FIG. 5 again. In one embodiment, the wrench heads 200 are respectively marked with length codes D1, D2, D3, and D4 (not shown in the drawings). According to the length of the adopted wrench head 200, the user uses the setting element 160 to set the corresponding length code D1, D2, D3, or D4 in the torque-compensation setting module 310. In one embodiment, each of the wrench heads 200 has at least one symbol A, B, C, or D, which is corresponding to the information that the torque-compensation setting module 310 uses to set the compensation mode. In one embodiment, the symbols A, B, C and D are the lengths of the wrench heads 200. In one embodiment, the symbols A, B, C and D are numerals, characters or patterns, which are corresponding to the information that the torque-compensation setting module 310 uses to set the compensation mode. According to the used wrench head 200, the setting element 160 sets the symbol A, B, C, or D in the torque-compensation setting module 310.

After the abovementioned compensation setting is completed, the allowable torque range conversion module 330 undertakes the conversion and update of the allowable torque range of the electronic torque wrench 100 to assist the user in operating the electronic torque wrench 100 correctly to avoid inappropriate tightening of the screw and damage of the electronic torque wrench 100. The allowable torque range has an upper limit and a lower limit The upper limit is the highest one of the torques that would not cause the permanent deformation of the selected wrench head 200 and the electronic torque wrench 100. While the applied torque exceeds the upper limit, the wrench heads 200 or the electronic torque wrench 100 would be deformed permanently and damaged. The lower limit is the torque, which is a minimum value excluding from the electronic noise and considering the measuring precision of the electronic torque wrench 100 of the selected wrench head 200. While the applied torque is lower than the lower limit, the displayed value would have an error too large to be accepted.

Suppose that the material of an electronic torque wrench allows a deformation amount of 100 μm and that a deformation amount of less than 20 μm will cause the abovementioned unacceptable error. Refer to FIG. 5 again. Further suppose that the allowable torque range has an upper limit of 100 Nm and a lower limit of 20 Nm for the wrench head 200 designated with C, i.e. the torque output by the electronic torque wrench 100 is allowed to be within 20-100 Nm.

While the wrench head 200 designated with C is replaced the wrench head 200 designated with D and having a larger length, the allowed deformation amount of the same wrench will be corresponding to a different allowable torque range because the moment arm is increased. For example, the allowable torque range becomes within 40-150 Nm for the longer wrench head 200. In such a case, if the electronic torque wrench 100 does not vary the allowable torque range for the wrench head 200 (D), the torque within 100-150 Nm cannot be measured to assist the user to operate the electronic torque wrench 100 in the range. The electronic torque wrench 100 using the wrench head 200 (D) has a lower limit of 40 Nm. If the allowable torque range is not updated, the measurement of the torque within 20-40 Nm would have a greater error and generates an invalid measurement value. If the original wrench head 200 is replaced by the wrench head 200 designated by B and having a smaller length, the allowable torque range becomes within 10-80 Nm. If the allowable torque range is not modified correspondingly, the torque within 10-20 Nm cannot be measured, and the torque within 80-100 Nm would deform the wrench too much and damage it.

In order to guarantee that the torque preset to output is within the allowable torque range and protect the wrench head 200 and the electronic torque wrench 100, the allowable torque range should be updated as soon as the wrench head 200 is changed. While the torque preset before replacement of the wrench head 200 exceeds the new operable torque, the electronic torque wrench 100 sends out an alarm instantly to inform the user to undertake resetting.

In summary, the present invention proposes an electronic torque wrench equipped with an automatic output-torque compensation device, wherein after replacement of the wrench head, the automatic output-torque compensation device undertakes operation, calculation and compensation to vary the allowable torque range, whereby to prevent the electronic torque wrench from being damaged, guarantee the precision of tightening the screw, and make the displayed torque equal to the actually output torque. Besides, the present invention uses the display element to present the displayed torque and the allowable torque range, whereby to enable the user to directly learn the output torque and the allowable torque range in real time and exempt the user from inconvenience and errors of calculating formulas. Therefore, the present invention can increase convenience, precision and reliability of electronic torque wrenches.

What is claimed is:

1. An electronic torque wrench equipped with an automatic output-torque compensation device, comprising
an electronic torque wrench;
a plurality of replaceable wrench heads respectively having different specifications and installed in the electronic torque wrench;
a torque-compensation setting module disposed in the electronic torque wrench and setting a length parameter corresponding to the specification of the wrench head selected by the electronic torque wrench;
an allowable torque range conversion module disposed in the electronic torque wrench and undertaking conversion and compensation according to the length parameter set by the torque-compensation setting module to vary an allowable torque range of the electronic torque wrench;
a torque-compensation conversion module disposed in the electronic torque wrench and undertaking conversion and compensation according to the length parameter set by the torque-compensation setting module to make a displayed torque presented by the electronic torque wrench identical to a torque actually output by the electronic torque wrench in operation; and
a display element disposed in the electronic torque wrench and presenting the displayed torque and the allowable torque range.

2. The electronic torque wrench equipped with an automatic output-torque compensation device according to claim 1 further comprising a memory module storing a plurality of compensation modes corresponding to the specifications of the wrench heads, wherein the torque-compensation conversion module) selects one corresponding compensation mode from the memory module.

3. The electronic torque wrench equipped with an automatic output-torque compensation device according to claim 1, wherein while a target torque is outside the allowable torque range of the electronic torque wrench, the electronic torque wrench sends out an alarm.

4. The electronic torque wrench equipped with an automatic output-torque compensation device according to claim 1, wherein the wrench head has at least one specified symbol corresponding to the specification thereof and also corresponding to information that the torque-compensation setting module uses to set a compensation mode.

5. The electronic torque wrench equipped with an automatic output-torque compensation device according to claim 4, wherein the specified symbol is a length corresponding to the wrench head.

6. The electronic torque wrench equipped with an automatic output-torque compensation device according to claim 1, wherein the allowable torque range has an upper limit, which is the highest one of torques that would not cause permanent deformation of the selected wrench head and the electronic torque wrench.

7. The electronic torque wrench equipped with an automatic output-torque compensation device according to claim 1, wherein the allowable torque range has a lower limit, which is a minimum value excluding from the electronic noise and considering the measuring precision of the electronic torque wrench of the selected wrench head.
